(19) United States
(12) Patent Application Publication
(10) Pub. No.: US 2022/0382252 A1
(43) Pub. Date: Dec. 1, 2022

(54) MACHINE CONTROL METHOD, MACHINE CONTROL SYSTEM, STORAGE MEDIUM, AND ELECTRONIC DEVICE

(71) Applicant: CHANGXIN MEMORY TECHNOLOGIES, INC., Hefei City (CN)

(72) Inventors: Ying XU, Hefei City (CN); Fei He, Hefei City (CN)

(21) Appl. No.: 17/658,863

(22) Filed: Apr. 12, 2022

(30) Foreign Application Priority Data
May 27, 2021 (CN) 202110585638.6

(51) Int. Cl. G05B 19/4155

(52) U.S. Cl. CPC G05B 19/4155; G05B 2219/45031

(57) ABSTRACT

The present disclosure relates to a machine control method, a machine control system, a computer-readable storage medium, and an electronic device. The machine control method includes: matching, based on input information of a machine, a plurality of corresponding sites that the machine needs to pass through and expected pass-through time of the machine in each of the plurality of corresponding sites; determining, based on actual time at which the machine arrives at a current site and the expected pass-through time of the machine in each of the plurality of corresponding sites, expected time at which the machine arrives at a subsequent site; and sending the expected time at which the machine arrives at the subsequent site.

### CROSS-REFERENCE TO RELATED APPLICATIONS

This disclosure claims the priority of Chinese Patent Application No. 202110585638.6, submitted to the Chinese Intellectual Property Office on May 27, 2021, the disclosure of which is incorporated herein in its entirety by reference.

### TECHNICAL FIELD

The present disclosure relates to the field of semiconductor production technologies, and specifically, to a machine control method, a machine control system, a computer-readable storage medium, and an electronic device.

### BACKGROUND

In a semiconductor production process, it is indispensable to purchase and transport production machines. In order to maximize a profit, it is necessary to formulate strict time for purchase, transportation, installation, commissioning, production, and other processes when purchasing a large quantity of machines.

However, due to some uncontrollable factors in a transportation process, time at which the machines arrive at a specific site cannot be accurately obtained. Therefore, detection and installation personnel cannot be reasonably arranged or resources cannot be allocated in time, resulting in a low transportation efficiency of the machines.

It should be noted that the information disclosed above is merely intended to facilitate a better understanding of the background of the present disclosure, and therefore may include information that does not constitute the prior art known to those of ordinary skill in the art.

### SUMMARY

According to a first aspect of the present disclosure, a machine control method is provided, including:

matching, based on input information of a machine, a plurality of corresponding sites that the machine needs to pass through and expected pass-through time of the machine in each of the plurality of corresponding sites;

determining, based on actual time at which the machine arrives at a current site and the expected pass-through time of the machine in each of the plurality of corresponding sites, expected time at which the machine arrives at a subsequent site; and

sending the expected time at which the machine arrives at the subsequent site.

According to a second aspect of the present disclosure, a machine control system is provided, including:

one or more processors; and

a storage apparatus, configured to store one or more programs, wherein the one or more programs, when executed by the one or more processors, cause the one or more processors to execute operations of:

matching, based on input information of a machine, a plurality of corresponding sites that the machine needs to pass through and expected pass-through time of the machine in each of the plurality of corresponding sites;

determining, based on actual time at which the machine arrives at a current site and the expected pass-through time of the machine in each of the plurality of corresponding sites, expected time at which the machine arrives at a subsequent site; and

sending the expected time at which the machine arrives at the subsequent site.

According to a third aspect of the present disclosure, a computer-readable storage medium is provided, where the computer-readable storage medium stores a computer program, and the computer program is executed by a processor to implement the above machine control method.

### BRIEF DESCRIPTION OF THE DRAWINGS

The accompanying drawings incorporated into the specification and constituting part of the specification illustrate the embodiments of the present disclosure, and serve, together with the specification, to explain the principles of the present disclosure. Apparently, the accompanying drawings in the following description show merely some embodiments of the present disclosure, and those of ordinary skill in the art may still derive other drawings from these accompanying drawings without creative efforts. In the accompanying drawings:

FIG. 1 is a flowchart of a machine control method according to an exemplary embodiment of the present disclosure;

FIG. 2 is a schematic flowchart of transportation and installation of a machine according to an exemplary embodiment of the present disclosure;

FIG. 3 is another schematic flowchart of transportation and installation of a machine according to an exemplary embodiment of the present disclosure;

FIG. 4 schematically illustrates an interface of a machine control system corresponding to a machine control method according to an exemplary embodiment of the present disclosure;

FIG. 5 schematically illustrates an interface of a machine in a transportation process according to an exemplary embodiment of the present disclosure;

FIG. 6 schematically and graphically illustrates a load status of a site according to an exemplary embodiment of the present disclosure;

FIG. 7 is a schematic flowchart of steps of a machine control method according to an exemplary embodiment of the present disclosure;

FIG. 8 is a block diagram of a machine control system according to an exemplary embodiment of the present disclosure; and

FIG. 9 is a schematic module diagram of an electronic device according to an exemplary embodiment of the present disclosure.

FIG. 10 is a block diagram of an electronic device according to an exemplary embodiment.

### DETAILED DESCRIPTION

Exemplary embodiments will be described below comprehensively with reference to the accompanying drawings. The exemplary embodiments may be implemented in various forms, and may not be construed as being limited to those described herein. On the contrary, these exemplary embodiments are provided to make the present disclosure comprehensive and complete and to fully convey the concept manifested therein to those skilled in the art. The same reference numerals in the figures indicate the same or similar parts, and thus their detailed descriptions will be omitted.

The described features, structures, or characteristics may be incorporated into one or more embodiments in any suitable manner. The following description offers many specific details in order for a full understanding of the embodiments of the present disclosure. However, those skilled in the art will be aware that the technical solutions of the present disclosure may be practiced with one or more of the specific details omitted, or other methods, components, apparatuses, steps, and the like may be used. In other cases, well-known structures, methods, apparatuses, implementations, materials, or operations are not shown or described in detail to avoid obscuring aspects of the present disclosure.

The block diagrams shown in the accompanying drawings are merely functional entities, which do not necessarily correspond to physically independent entities. That is, these functional entities may be implemented in a form of software, or these functional entities or parts of the functional entities may be implemented in one or more software-hardened modules, or these functional entities may be implemented in different networks and/or processor apparatuses and/or microcontroller apparatuses.

A semiconductor machine is needed during semiconductor production and processing, for example, a single crystal furnace, a vapor phase epitaxy furnace, an oxidation furnace, a magnetron sputtering apparatus, a chemical-mechanical polishing machine, a lithography machine, an ion implanter, a wire bonding machine, a wafer dicing machine, or a wafer thinning machine. For a semiconductor company, a large quantity of semiconductor machines need to be purchased to meet production needs.

In order to maximize a profit, it is necessary to formulate strict time for purchase, transportation, installation, commissioning, production, and other nodes when purchasing the semiconductor machines. A most important node of purchasing the machines is machine transportation and installation. Generally, a transportation process is divided into a plurality of sites (places for loading and commissioning machine parts). Each site is assigned corresponding personnel responsible for equipment inspection and loading of relevant parts.

However, due to some uncontrollable factors in the transportation process, data such as time of arriving at a specific site, a current location of the machines, and inspection information of machine installation at each site cannot be accurately obtained, resulting in the following problems: 1) A person in charge of the site is unable to know time at which the machines arrive at the site and statuses of the machines, and cannot reasonably arrange personnel to detect and install the machines, causing a waste of manpower and a high waiting cost. 2) In case of delayed machine transportation/installation, resources cannot be regulated and controlled in time to ensure continuity of production, thereby increasing a time cost and resulting in a potential threat such as a delayed delivery.

Based on this, an exemplary implementation of the present disclosure provides a machine control method, to manage and control a transportation process of a machine, accurately control time at which the machine arrives at a site, reduce a communication cost, and improve transportation efficiency of the machine. A test device and a semiconductor device belong to a same kind of device.

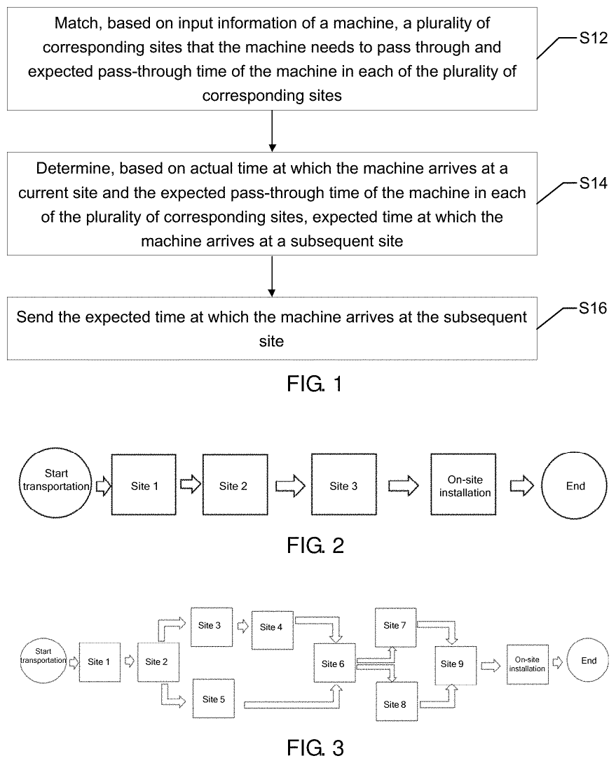

FIG. 1 is a flowchart of a machine control method according to an exemplary embodiment of the present disclosure. As shown in FIG. 1, the machine control method may include:

Step S12: Match, based on input information of a machine, a plurality of corresponding sites that the machine needs to pass through and expected pass-through time of the machine in each of the plurality of corresponding sites.

Step S14: Determine, based on actual time at which the machine arrives at a current site and the expected pass-through time of the machine in each of the plurality of corresponding sites, expected time at which the machine arrives at a subsequent site.

Step S16: Send the expected time at which the machine arrives at the subsequent site.

On one hand, the machine control method provided in the exemplary implementation of the present disclosure inputs the information of the machine, and obtains, through matching based on the information of the machine, the sites that the machine needs to pass through and the expected pass-through time of the machine in each of the plurality of corresponding sites; and determines, based on information of the sites, the expected pass-through time of the machine in each of the plurality of corresponding sites, and the actual time at which the machine arrives at the current site, the expected time at which the machine arrives at the subsequent site. In this way, the expected time at which the machine arrives at the subsequent site can be accurately determined based on the actual time at which the machine arrives at the current site. In this way, personnel can be arranged in time for the subsequent site based on the expected time at which the machine arrives at the subsequent site, to detect and install the machine, so as to reduce a personnel waiting cost and a waste of manpower. In addition, whether transportation/installation of the machine is delayed can be determined based on the expected time at which the machine arrives at the subsequent site, so as to regulate and control resources in time to ensure continuity of production, thereby reducing a time cost and delayed deliveries. On the other hand, the machine control method provided in the exemplary implementation of the present disclosure mainly determines, based on the actual time at which the machine arrives at the current site, the expected time at which the machine arrives at the subsequent site. Therefore, accurate time at which the machine arrives at the subsequent site can be re-determined based on actual time at which the machine arrives at a different current site each time, so as to improve flexibility and real-time performance of machine control, reflect an actual situation of the machine during transportation and assembling in time, improve real-time performance and accuracy of obtaining transportation information of the machine, and achieve a purpose of accurately controlling a time node and effectively saving a communication cost.

The following describes in detail the machine control method in the exemplary implementation of the present disclosure with reference to embodiments.

In step S12, the plurality of corresponding sites that the machine needs to pass through and the expected pass-through time of the machine in each of the plurality of corresponding sites are matched based on the input information of the machine.

During actual transportation and installation of the machine, sites that different machines pass through may be different. Even for machines of a same type, there will be different site settings as required. For example, for the machines of a same type, some are equipped with a cleaning system, while others do not need to be equipped with the cleaning system. In this way, corresponding sites are added for the machines equipped with the cleaning system.

FIG. 2 and FIG. 3 are flowcharts of transportation and installation of two machines. Machine 1 shown in FIG. 2 passes through a total of three sites from the beginning of transportation to on-site installation. Machine 2 shown in FIG. 3 passes through a total of nine sites from the beginning of transportation to on-site installation. In addition, in a process of passing through site 2 to site 6, machine 2 passes through sites 3 and 4, and site 5 concurrently, where parts loading processes at sites 3 and 4 and a parts loading process at site 5 are different processes performed at a same location. Similarly, in a process of passing through site 6 to site 9, machine 2 also passes through site 7 and site 8 concurrently, and two parts assembling processes may be concurrently performed at site 7 and site 8. Therefore, the sites described in the exemplary implementation of the present disclosure each not only represent a transportation site that the machine passes through during transportation, but also may be an installation and commissioning site for machine loading and parts commissioning. In addition, the transportation site is usually located between two adjacent installation and commissioning sites. For example, site 2 and site 6 may be transportation sites. The transportation site may be a site for transportation by air, land, or sea. In a process of determining expected time of arriving at the site, only expected pass-through time of the machine in the transmission site needs to be provided.

In the exemplary implementation of the present disclosure, the information of the plurality of sites can be determined based on an installation and commissioning process of the machine during actual transportation involved in a semiconductor production process, and the information of the sites and time required for the installation and commissioning process at each of the plurality of corresponding sites, namely, the expected pass-through time of the machine in each of the plurality of corresponding sites, can be stored in a database. After information of a machine is input by staff, a site matching the machine and expected pass-through time of the machine in the site can be obtained from the database based on the information of the machine, thereby achieving automatic matching. In addition, the staff can also adjust the matching site based on an actual situation, for example, add a new site for a machine, or delete some sites for a machine, so as to improve flexibility of machine control.

In step S14, the expected time at which the machine arrives at the subsequent site is determined based on the actual time at which the machine arrives at the current site and the expected pass-through time of the machine in each of the plurality of corresponding sites.

After the sites that the machine needs to actually pass through and the expected pass-through time of the machine in each of the plurality of corresponding sites are determined, the expected time at which the machine arrives at the subsequent site can be calculated in combination with the actual time at which the machine arrives at the current site, and the expected time at which the machine arrives at the subsequent site can be adjusted based on actual pass-through time of the machine in a previous site, so as to improve accuracy of the determined expected time at which the machine arrives at the subsequent site.

However, in an actual site determining process, some sites each may include a plurality of sub-sites. As shown in FIG. 3, sites 3 and 4 and site 5 are sub-sites. Before arriving at site 6, the machine needs to pass through sites 3 and 4 and site 5. Concurrent processing may be performed at sites 3 and 4 and site 5. Therefore, time of arriving at site 6 from site 2 includes expected time during which the machine passes through sites 3 and 4, and expected time during which the machine passes through site 5. In addition, a maximum value of expected pass-through time of the machine in the plurality of sub-sites needs to be determined as expected pass-through time of the machine in the current site. That is, it is necessary to compare the expected time during which the machine passes through sites 3 and 4, and the expected time during which the machine passes through site 5, and determine the larger one as the expected pass-through time of the machine in the current site.

For example, if the expected time during which the machine passes through site 5 is greater than the expected time during which the machine passes through sites 3 and 4, expected time of arriving at site 6 is estimated based on the expected time during which the machine passes through site 5. If the expected time during which the machine passes through sites 3 and 4 is greater than the expected time during which the machine passes through site 5, the expected time of arriving at site 6 is estimated based on the expected time during which the machine passes through sites 3 and 4.

During actual machine installation and transportation, in addition to the expected pass-through time that is of the sites and stored in the database, there may be a time delay caused by other factors and a time advance caused by early processing. In this case, it is necessary to perform collection based on a time change caused by an actual factor, and adjust the expected pass-through time, that is, to determine actual pass-through time of the machine in the current site, and adjust, based on the actual time of the machine in the current site, the expected time at which the machine arrives at the subsequent site.

In the exemplary implementation of the present disclosure, an example in which there is pause time is used. If there is pause time when the machine arrives at the current site, for example, repair time when the machine is damaged during transportation, or the machine fails to be installed and commissioned based on predetermined expected pass-through time due to other factors. In this case, the expected time at which the machine arrives at the subsequent site needs to be adjusted based on the original expected pass-through time and the pause time, that is, adding the pause time, to improve accuracy of determining the expected time at which the machine arrives at the subsequent site.

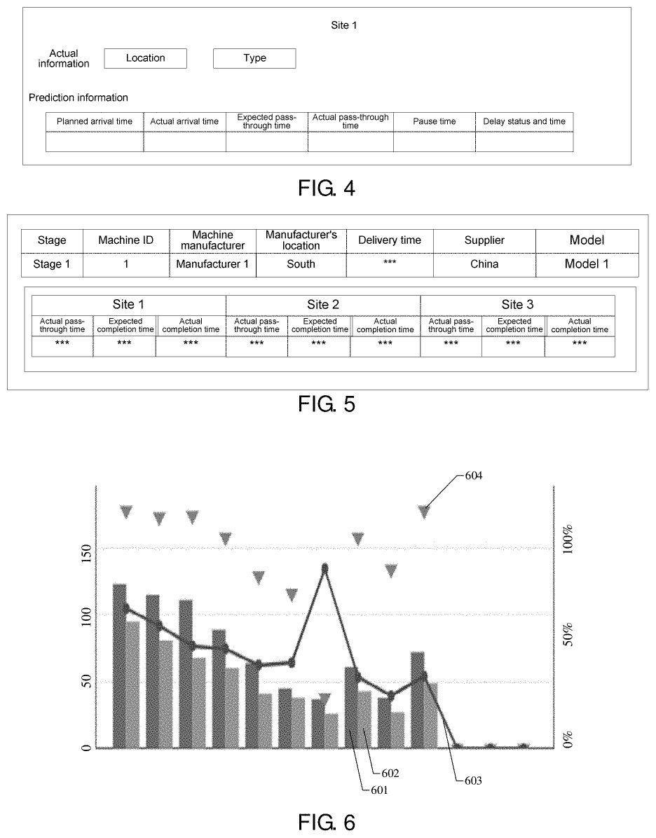

It should be noted that the above pause time may be added by setting a corresponding time adjustment module on an interface, shown in FIG. 4, of a machine control system corresponding to the machine control method, such that a person in charge of the current site can adjust the actual time of the machine in the current site based on an actual situation.

It should be additionally noted that actual information and prediction information about site 1 are listed in FIG. 4. The actual information may include a location and a type of the site. For example, the type of the site may be the installation and commissioning site or the transportation site. The prediction information may include the above expected arrival time, actual arrival time, expected pass-through time, actual pass-through time, pause time, delay status, delay time, and the like. The above actual information and prediction information may be calculated automatically by the system or input by the staff based on an actual situation, which may be specifically determined based on an actual situation.

In step S16, the expected time at which the machine arrives at the subsequent site is sent.

After the expected time at which the machine arrives at the subsequent site is determined, it can be sent to staff of the subsequent site, for example, to a system managed by the staff of the subsequent site, informed to relevant staff by using an SMS, or the like, which is not specifically limited herein.

After determining expected time of arriving at each of the plurality of corresponding sites, the machine control method provided in the exemplary implementation of the present disclosure can further compare the actual time at which the machine arrives at the current site and expected time at which the machine arrives at the current site, to determine whether there is a delay when the machine arrives at the current site. In case of a delay, the staff can investigate and analyze a reason for the delay, and adjust expected pass-through time of the machine in a site based on the actual delay, so as to realize a more reasonable process of determining expected time at which the machine arrives at the site. In addition, an actual transportation and assembling process can also be adjusted and improved based on the delay, so as to improve transportation efficiency of the machine.

In practical applications, in order to facilitate the staff to pay attention to the delay in time, as shown in FIG. 5, a result of whether there is a delay when the machine arrives at the current site can be displayed distinctively, for example, a delayed site is highlighted or displayed in a different color. A way of distinctive display is not specifically limited in the exemplary implementation of the present disclosure.

FIG. 5 schematically illustrates an interface of a machine in a whole transportation process. The machine passes through three sites from site 1 to site 3. Actual pass-through time, expected completion time, and actual completion time are displayed for each site. It should be noted that the expected completion time is determined based on expected time of arriving at the site and expected pass-through time of the machine in the site. The actual completion time is determined based on actual time of arriving at the site and the actual pass-through time of the machine in the site. In addition, FIG. 5 also shows relevant information of the machine, such as a current stage of the machine, a manufacturer of the machine, a location of the manufacturer, delivery time, a supplier, and a model.

Moreover, in an actual transportation process of a plurality of machines, a plurality of machines may be processed at the same time at some sites. Therefore, calculating an actual quantity of running machines of each of the plurality of corresponding sites within a preset time period is also an important way to master the transportation process of the machines.

The machine control method provided in the exemplary implementation of the present disclosure further can compare the actual quantity of running machines of the site and a preset quantity of running machines of the site, to determine a load rate of the site, and determine, based on the load rate, whether the current site is overloaded.

FIG. 6 schematically and graphically illustrates a load status of a site. In the figure, a left histogram 601 corresponding to each site represents a preset quantity of running machines of the site, a right histogram 602 represents an actual quantity of running machines of the site, and a broken line 603 represents a ratio of the actual quantity of running machines to the preset quantity of running machines, and an inverted triangle 604 represents a total quantity of machines processed at the site up to now. A status of the machine running in each site can be determined based on the structure shown in FIG. 6, so as to provide reference for adjusting the transportation of the machine and prevent the site from being overloaded.

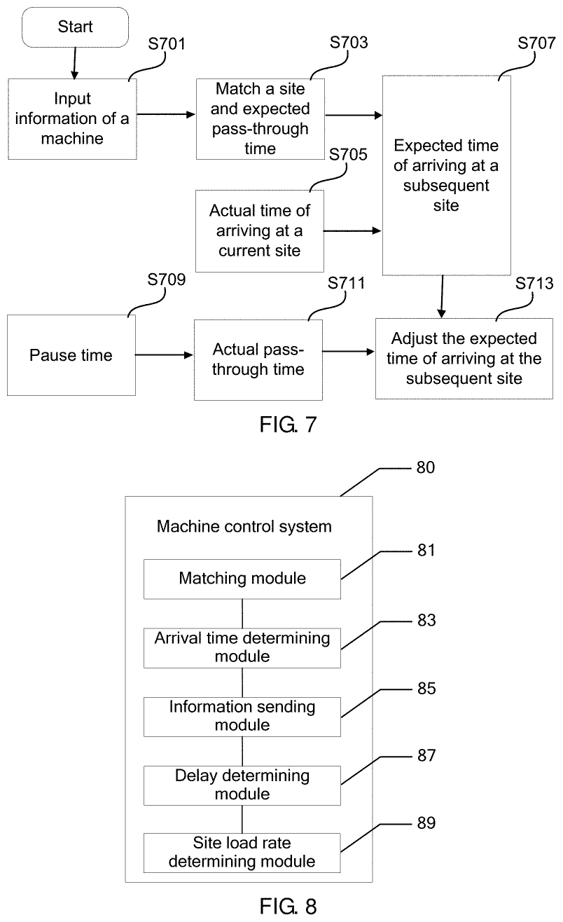

FIG. 7 is a flowchart of steps of a machine control method provided in an exemplary implementation of the present disclosure. As shown in FIG. 7, in step S701, information of a machine is input. Specifically, the information of the machine may be input to a corresponding machine control system by staff. In step S703, a site and expected pass-through time of the machine in each site are matched based on the input information of the machine. Based on actual time of arriving at a current site that is input in step S705, expected time of arriving at a subsequent site is obtained in step S707. The actual time of arriving at the current site may alternatively be time at which a whole transportation process starts.

In addition, if there is pause time or other special cases in a transportation process of the machine, step S709 needs to be performed to input the pause time by the staff. Then, step S711 is performed to determine actual pass-through time of the machine in the current site. Finally, step S713 is performed to adjust, based on the actual pass-through time of the machine in the current site, the expected time of arriving at the subsequent site that is obtained in step S707.

It should be noted that although the steps of the method in the present disclosure are described in the accompanying drawings in a particular sequence, it is not required or implied that the steps must be performed in that particular sequence or that all of the steps shown must be performed to achieve the desired results. Additionally or alternatively, some steps may be omitted, a plurality of steps may be combined into a single step for execution, and/or a single step may be divided into a plurality of steps for execution.

An exemplary embodiment further provides a machine control system. FIG. 8 is a block diagram of a machine control system according to an exemplary embodiment of the present disclosure. As shown in FIG. 8, the machine control system 80 may include a matching module 81, an arrival time determining module 83, and an information sending module 85.

The matching module 81 may be configured to match, based on input information of a machine, a plurality of corresponding sites that the machine needs to pass through and expected pass-through time of the machine in each of the plurality of corresponding sites.

The arrival time determining module 83 may be configured to determine, based on actual time at which the machine arrives at a current site and the expected pass-through time of the machine in each of the plurality of corresponding sites, expected time at which the machine arrives at a subsequent site.

The information sending module 85 may be configured to send the expected time at which the machine arrives at the subsequent site.

In any optional embodiment of the present disclosure, the arrival time determining module 83 is further configured to: if the current site includes a plurality of sub-sites, determine a maximum value of expected pass-through time of the machine in the plurality of sub-sites as expected pass-through time of the machine in the current site.

In any optional embodiment of the present disclosure, the arrival time determining module 83 is further configured to adjust, based on the actual time at which the machine arrives at the current site, the expected time at which the machine arrives at the subsequent site.

In any optional embodiment of the present disclosure, the arrival time determining module 83 is further configured to: if there is pause time when the machine arrives at the current site, adjust, based on the pause time, the expected time at which the machine arrives at the subsequent site.

In any optional embodiment of the present disclosure, the machine control system 80 further includes a delay determining module 87, configured to compare the actual time at which the machine arrives at the current site and expected time at which the machine arrives at the current site, to determine whether there is a delay when the machine arrives at the current site.

In any optional embodiment of the present disclosure, the delay determining module 87 is configured to distinctively display a result of whether there is the delay when the machine arrives at the current site.

In any optional embodiment of the present disclosure, the machine control system 80 further includes a site load rate determining module 89, configured to: calculate an actual quantity of running machines of each of the plurality of corresponding sites within a preset time period; and compare the actual quantity of running machines of the site and a preset quantity of running machines of the site, to determine a load rate of the site.

In any optional embodiment of the present disclosure, the plurality of sites include installation and commissioning sites and a transportation site, and the transportation site is located between two adjacent installation and commissioning sites.

Specific details and explanations of the above modules have been provided in the foregoing embodiments, and details are not described herein again.

It should be noted that although several modules or units of the machine control system are mentioned in the above description, such division of modules or units is not mandatory. In fact, according to the implementations of the present disclosure, the features and functions of two or more modules or units described above may be embodied in one module or unit. Correspondingly, the features and functions of a module or unit described above may be further divided into a plurality of modules or units to be embodied.

An exemplary embodiment of the present disclosure further provides an electronic device that can be configured to implement the foregoing method.

Those skilled in the art can understand that aspects of the present disclosure may be implemented as systems, methods, or program products. The aspects of the present disclosure may be specifically implemented in a form of a fully hardware implementation, a fully software implementation (including firmware, microcode, or the like), or a combination of hardware and software, which may be collectively referred to as a “circuit”, “module”, or “system”.

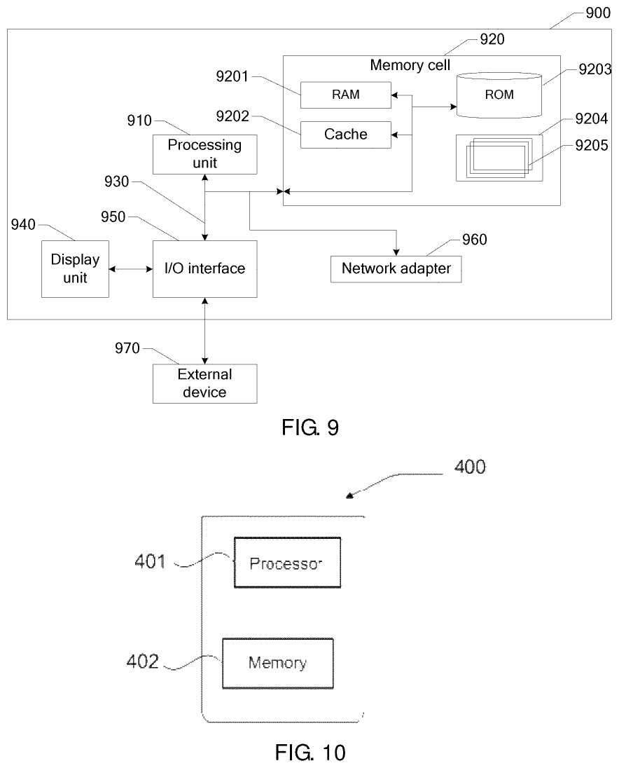

An electronic device 900 according to the implementation of the present disclosure is described below with reference to FIG. 9. The electronic device 900 shown in FIG. 9 is only an example, which should not be construed as any limitation on the function and application scope of the embodiment of the present disclosure.

As shown in FIG. 9, the electronic device 900 is represented in the form of a general purpose computer. Components of the electronic device 900 may include, but are not limited to, at least one processing unit 910, at least one memory cell 920, a bus 930 connecting different system components (including the memory cell 920 and the processing unit 910), and a display unit 940.

The memory cell 920 stores program code which can be executed by the processing unit 910, such that the processing unit 910 performs the steps according to the exemplary implementations of the present disclosure described in the “exemplary methods” of the specification. For example, the processing unit 910 can perform the following steps shown in FIG. 1: step S12: matching, based on input information of a machine, a plurality of corresponding sites that the machine needs to pass through and expected pass-through time of the machine in each of the plurality of corresponding sites; step S14: determining, based on actual time at which the machine arrives at a current site and the expected pass-through time of the machine in each of the plurality of corresponding sites, expected time at which the machine arrives at a subsequent site; and step S16: sending the expected time at which the machine arrives at the subsequent site.

The memory cell 920 may include a readable medium in the form of a volatile memory cell, for example, a random access memory cell (RAM) 9201 and/or a cache memory cell 9202, and may further include a read-only memory cell (ROM) 9203.

The memory cell 920 may alternatively include a program/utility 9204 including a set of (at least one) program modules 9205, and the program module 9205 includes, but is not limited to: an operating system, one or more applications, other program modules and program data. Each of these examples or some combination thereof may include an implementation of a network environment.

The bus 930 may be one or more of several types of bus structures, including a memory cell bus or a memory cell controller, a peripheral bus, a graphics acceleration port, a processing unit, or a local area bus using any of a plurality of bus structures.

The electronic device 900 may further communicate with one or more external devices 970 (for example, a keyboard, a pointing device, or a Bluetooth device), with one or more devices that enable a user to interact with the electronic device 900, and/or with any device that enables the electronic device 900 to communicate with one or more other computing devices (for example, a router or a modem). Such communication may be performed through an input/output (I/O) interface 950. The electronic device 900 may further communicate with one or more networks (for example, a local area network (LAN), a wide area network (WAN), and/or a public network such as the Internet) through a network adapter 960. As shown in the figure, the network adapter 960 communicates with other modules of the electronic device 900 through the bus 930. It should be understood that although not shown in the figure, other hardware and/or software modules may be used in combination with the electronic device 900, including but not limited to: microcode, a device driver, a redundant processing unit, an external disk drive array, a RAID system, a tape driver, and a data backup storage system.

Through the foregoing description of the implementations, persons skilled in the art may easily understand that the exemplary implementations described herein may be implemented by software, or may be implemented by software in combination with necessary hardware. Therefore, the technical solutions according to the implementations of the present disclosure may be implemented in a form of a software product. The software product may be stored in a non-volatile storage medium (which may be a compact disk read-only memory (CD-ROM), a USB flash drive, a removable hard disk, or the like) or on the network, and includes a plurality of instructions to cause a computing device (which may be a personal computer, a server, a terminal apparatus, a network device, or the like) to perform the method according to the implementations of the present disclosure.

An exemplary embodiment of the present disclosure further provides a computer-readable storage medium, where the computer-readable storage medium stores a program product that can be used to implement the method in the specification. In some possible implementations, various aspects of the present disclosure may also be realized in a form of a program product, which includes program code. When the program product runs on a terminal device, the program code is used to enable the terminal device to perform the steps according to various exemplary implementations of the present disclosure described in the foregoing “exemplary methods” of the specification.

An exemplary embodiment of the present disclosure provides a machine control system. Referring to FIG. 10, the electronic device 400 may be provided as a terminal device. the electronic device 400 may include a processor 401, and one or more processors may be set as required. The electronic device 400 may further include a memory 402 configured to store an executable instruction, such as an application program, of the processor 401. One or more memories may be set as required. The memory may store one or more application programs. The processor 401 is configured to execute the instruction to perform the foregoing method.

As shown in FIG. 5, a program product 500 for implementing the above method according to an implementation of the present disclosure is depicted, which may employ a portable CD-ROM and include program code, and may run on a terminal device, such as a personal computer. However, the program product of the present disclosure is not limited hereto. In the present disclosure, the computer-readable storage medium may be any tangible medium that contains or stores a program, and the program may be used by or in combination with an instruction execution system, apparatus, or device.

The program product may be any combination of one or more readable media. The readable medium may be a readable signal medium or a readable storage medium. The readable storage medium, may be, for example, but not limited to, electrical, magnetic, optical, electromagnetic, infrared, or semiconductor systems, apparatuses, or devices, or any combination thereof. More specific examples (non-exhaustive) of the readable storage medium include an electrical connection with one or more conducting wires, a portable computer disk, a hard disk, a RAM, a ROM, an erasable programmable ROM (an EPROM or a flash memory), an optical fiber, a portable CD-ROM, an optical storage device, a magnetic storage device, or any suitable combination thereof.

The computer-readable signal medium may include a data signal propagated in a baseband or as a part of a carrier, and readable program code is carried therein. The propagated data signal may be in various forms, including but not limited to an electromagnetic signal, an optical signal, or any suitable combination thereof. The readable signal medium may alternatively be any readable medium other than the readable storage medium. The readable medium may send, propagate, or transmit a program configured to be used by or in combination with an instruction execution system, apparatus, or device.

The program code contained on the readable medium may be transmitted using any suitable medium, including but not limited to: wireless, wire, optical fiber, RF, or any suitable combination thereof.

Program code for executing the operations in the present disclosure may be compiled by using one or more programming languages or any combination thereof. The programming languages include object oriented programming languages, such as Java and C++, and conventional procedural programming languages, such as C or similar programming languages. The program code can be executed fully on a user computer, executed partially on a user device, executed as an independent software package, executed partially on a user computer and partially on a remote computer, or executed fully on a remote computer or a server. In a circumstance in which a remote computer is involved, the remote computer may be connected to a user computer via any type of network, including a LAN or a WAN, or may be connected to an external computer (for example, connected via the Internet by using an Internet service provider).

In addition, the foregoing accompanying drawings are merely schematic illustrations of the processes included in the method according to the exemplary embodiments of the present disclosure, and are not intended for limitation. It is easily understood that the processes shown in the foregoing accompanying drawings does not indicate or impose a limit on the chronological sequence of these processes. In addition, it is also easily understood that these processes can be performed synchronously or asynchronously, for example, in a plurality of modules.

Those skilled in the art can readily figure out other embodiments of the present disclosure after considering the specification and practicing the content disclosed herein. The present disclosure is intended to cover any variations, purposes or adaptive changes of the present disclosure. Such variations, purposes or applicable changes follow the general principle of the present disclosure and include common knowledge or conventional technical means in the technical field which is not disclosed in the present disclosure. The specification and embodiments are merely considered as illustrative, and the real scope and spirit of the present disclosure are pointed out by the claims.

It should be noted that, the present disclosure is not limited to the precise structures described above and shown in the accompanying drawings, and can be modified and changed in many ways without departing from the scope of the present disclosure. The scope of the present disclosure is defined by the appended claims.

1. A machine control method, comprising:
matching, based on input information of a machine, a plurality of corresponding sites that the machine needs to pass through and expected pass-through time of the machine in each of the plurality of corresponding sites;
determining, based on actual time at which the machine arrives at a current site and the expected pass-through time of the machine in each of the plurality of corresponding sites, expected time at which the machine arrives at a subsequent site; and
sending the expected time at which the machine arrives at the subsequent site.

2. The machine control method according to claim 1, wherein when the current site comprises a plurality of sub-sites, a maximum value of expected pass-through time of the machine in the plurality of sub-sites is determined as expected pass-through time of the machine in the current site.

3. The machine control method according to claim 1, the method further comprises:
adjusting, based on the actual time at which the machine arrives at the current site, the expected time at which the machine arrives at the subsequent site.

4. The machine control method according to claim 3, wherein when there is pause time when the machine arrives at the current site, the expected time at which the machine arrives at the subsequent site is adjusted based on the pause time.

5. The machine control method according to claim 1, the method further comprises:
comparing the actual time at which the machine arrives at the current site and expected time at which the machine arrives at the current site, to determine whether there is a delay when the machine arrives at the current site.

6. The machine control method according to claim 5, wherein a result of whether there is the delay when the machine arrives at the current site is displayed distinctively.

7. The machine control method according to claim 1, the method further comprises:
calculating an actual quantity of running machines of each of the plurality of corresponding sites within a preset time period; and
comparing the actual quantity of running machines of the site and a preset quantity of running machines of the site, to determine a load rate of the site.

8. The machine control method according to claim 1, wherein the plurality of sites comprise installation and commissioning sites and a transportation site, and the transportation site is located between two adjacent installation and commissioning sites.

9. A machine control system, comprising:
one or more processors; and
a storage apparatus, configured to store one or more programs, wherein the one or more programs, when executed by the one or more processors, cause the one or more processors to execute operations of:
matching, based on input information of a machine, a plurality of corresponding sites that the machine needs to pass through and expected pass-through time of the machine in each of the plurality of corresponding sites;
determining, based on actual time at which the machine arrives at a current site and the expected pass-through time of the machine in each of the plurality of corresponding sites, expected time at which the machine arrives at a subsequent site; and
sending the expected time at which the machine arrives at the subsequent site.

10. The machine control system according to claim 9, wherein the one or more programs cause the one or more processors to execute operations of: when the current site comprises a plurality of sub-sites, determining a maximum value of expected pass-through time of the machine in the plurality of sub-sites as expected pass-through time of the machine in the current site.

11. The machine control system according to claim 9, wherein the one or more programs cause the one or more processors to execute operations of: adjusting, based on the actual time at which the machine arrives at the current site, the expected time at which the machine arrives at the subsequent site.

12. The machine control system according to claim 11, wherein the one or more programs cause the one or more processors to execute operations of: when there is pause time when the machine arrives the current site, adjusting, based on the pause time, the expected time at which the machine arrives at the subsequent site.

13. The machine control system according to of claim 9, the one or more programs cause the one or more processors to execute operations of:
comparing the actual time at which the machine arrives at the current site and expected time at which the machine arrives at the current site, to determine whether there is a delay when the machine arrives at the current site.

14. The machine control system according to claim 13, wherein the one or more programs cause the one or more processors to execute operations of: distinctively displaying a result of whether there is the delay when the machine arrives at the current site.

15. The machine control system according to of claim 9, the one or more programs cause the one or more processors to execute operations of:
calculating an actual quantity of running machines of each of the plurality of corresponding sites within a preset time period; and comparing the actual quantity of running machines of the site and a preset quantity of running machines of the site, to determine a load rate of the site.

16. The machine control system according to claim 9, wherein the plurality of sites comprise installation and commissioning sites and a transportation site, and the transportation site is located between two adjacent installation and commissioning sites.

17. A computer-readable storage medium, wherein the computer-readable storage medium stores a computer program, and the computer program is executed by a processor to implement the machine control method according to of claim 1.
